(19) United States
(12) Patent Application Publication
(10) Pub. No.: US 2020/0017035 A1
(43) Pub. Date: Jan. 16, 2020

(54) VIEWING DEVICE, ASSOCIATED DRIVING ASSISTANCE SYSTEM AND METHOD FOR MAINTAINING VISIBILITY

(71) Applicant: Valeo Systèmes d'Essuyage, Le Mesnil Saint Denis (FR)

(72) Inventors: Frédéric Bretagnol, Issoire (FR); Giuseppe Grasso, Issoire (FR); Grégory Kolanowski, Issoire (FR); Marcel Trebouet, Le Mesnil Saint Denis (FR)

(73) Assignee: Valeo Systèmes d'Essuyage, Le Mesnil Saint Denis (FR)

(21) Appl. No.: 16/483,894

(22) PCT Filed: Feb. 6, 2018
(86) PCT No.: PCT/EP2018/052857

§ 371 Date: Aug. 6, 2019

(30) Foreign Application Priority Data
Feb. 8, 2017 (FR) 1751025

(51) Int. Cl. B60R 11/04; H04N 5/225; B60S 1/56

(52) U.S. Cl. CPC B60R 11/04; B60R 2011/0085; B60S 1/56; H04N 5/2252

(57) ABSTRACT

The invention relates to a viewing device (3) for a motor vehicle, comprising: an optical sensor (5) configured to capture at least one image of a road scene and a mounting (7) for the optical sensor (5). According to the invention: the optical sensor (5) is rotatably mounted on the mounting (7), and said device (3) also includes an actuator (9) configured to rotate the optical sensor (5). The invention likewise relates to a driving assistance system comprising such a device (3) and to a method for maintaining the visibility of the optical sensor (5) of said viewing device (3).

The present invention relates to the field of driving assistance and particularly to the driving assistance systems, installed on certain vehicles, wherein the driving assistance system can include an optical sensor, like, for example, a camera comprising a lens. More particularly, the invention relates to a viewing device comprising such an optical sensor. The invention also relates to a method for maintaining the visibility of an optical sensor of such a viewing device.

Today, viewing front, rear, or lateral cameras are provided on a large number of motor vehicles in order to improve the viewing of the environment of the vehicle by the user. Notably, they are part of driving assistance systems, such as parking assistance systems for facilitating the vehicle maneuvers, or lane departure detection systems.

Cameras are known which are fitted inside the passenger compartment of a vehicle against the rear window/glass directed toward the rear from the rear window of the vehicle. These cameras are well protected from the weather influences outside or fouling caused by organic or inorganic pollutants. These cameras can, for example, benefit from the systems for deicing and cleaning the rear window, such as a heating wire integrated in the glass of the rear window.

However, the viewing angle for such cameras is not optimal, in particular for parking assistance, since they do not make it possible to see the obstacles that are located close to the rear of the vehicle, for example.

For this reason, it is preferable for the camera to be arranged outside the vehicles at different locations depending on the desired use, for example at the rear or front bumper, or at the rear or front license plate of the vehicle.

In this case, the camera is therefore greatly exposed to splashes of dirt which can be deposited on the optics thereof and thus reduce the effectiveness thereof, or render it inoperable.

In particular, when it rains, splashes of rain and dirt are observed which can greatly affect the operability of the driving assistance system comprising such a camera. The surfaces of the optics of the cameras must be cleaned in order to ensure the good operating state thereof.

To counter the depositing of dirt on the camera, it is known to arrange a device for cleaning the optics of the camera, generally a cleaning liquid jet, close thereto, in order to get rid of the polluting elements which are deposited over time.

However, the optics of the camera, a relatively fragile element, are not protected from splashes that can damage them. Moreover, the use of these jets lead to an increase in the operating costs since they require the use of quite large quantities of cleaning liquid.

It is also known to mount the camera inside an external trim of the vehicle, and to protect it from external aggression by means of a protective glass fixed to the trim. However, although the camera is protected from external aggression, the protective glass or window remains subjected to the depositing of pollutants. This requires the use of a device for cleaning the protective glass like, for example, a wiper which interferes with the field of vision of the camera during the use thereof.

It is therefore advisable to propose an alternative viewing device which makes it possible to protect the optical sensor, such as a camera, from possible splashing and makes it possible to limit, as best as possible, the hindrance to the field of vision.

To this end, the object of the invention is a viewing device for a motor vehicle comprising:
an optical sensor configured to take at least one image of a road scene and
a support for the optical sensor.

According to the invention:
the optical sensor is rotatably mounted on the support, and
said device also includes an actuator configured to rotate the optical sensor.

When the optical sensor is rotated by the actuator, the possible fouling which would have been deposited on the optics of the optical sensor is ejected by centrifugal effect. “Fouling” means both drops of water and organic or inorganic pollutants. Thus, the optical sensor retains a good level of operability and the soiling thereof is limited regardless of the weather conditions.

The rotation of the optical sensor therefore allows removal of the pollutants and/or of the water under the effect of the centrifugal force.

The device can further include one or more following features, taken separately or in combination:
said device further includes a means for supplying power to the optical sensor using an energy transmission technology that is at least partially wireless,
the transmission of energy occurs at least partially by induction,
the power supply means comprises a fixed connector configured to be electrically powered, and a mobile connector configured to be powered by electromagnetic coupling to the fixed connector and configured to power the optical sensor with the induced current;
the fixed connector is configured to be linked to the network of said vehicle;
the mobile connector is rotationally coupled to the optical sensor;
the fixed connector and the mobile connector have a substantially annular shape;
the mobile connector is arranged inside the fixed connector;
the rotation axis of the optical sensor is merged with the optical axis of the optical sensor;
the actuator comprises a motor with a fixed stator and a rotor mobile with respect to the stator;
the motor is a brush less motor;
the fixed connector is fixed to the stator and the mobile connector is fixed to the rotor;
the motor is hollow and the optical sensor is arranged at least partially inside the motor;
the optical sensor is centered in the motor;
the support is fixed to the stator;
the fixed connector is arranged on the stator on the opposite side to the support for the optical sensor;
the support has a through-housing for at least partially receiving the optical sensor;
the support has a substantially annular shape;
the optical sensor includes optics configured to be arranged flush with the body of a motor vehicle;
the optics of the optical sensor have at least one property chosen from the following list: infrared filter for example photocatalytic, hydrophobic, superhydrophobic, oleophobic, hydrophilic, superhydrophilic, resistance to chippings.

The invention also relates to a driving assistance system comprising at least one viewing device as described above.

The invention further relates to a method for maintaining the visibility of a viewing device as described above, said method comprising at least one step for rotating the optical sensor.

Said method comprises at least two steps with an optical sensor rotation speed that is different for each step.

Said method comprises a step of adjusting the optical sensor rotation speed as a function of the speed of the motor vehicle provided with the viewing device.

Other features and advantages of the invention will emerge more clearly upon reading the following description, given by way of illustrative and nonlimiting example, and the appended drawings wherein:

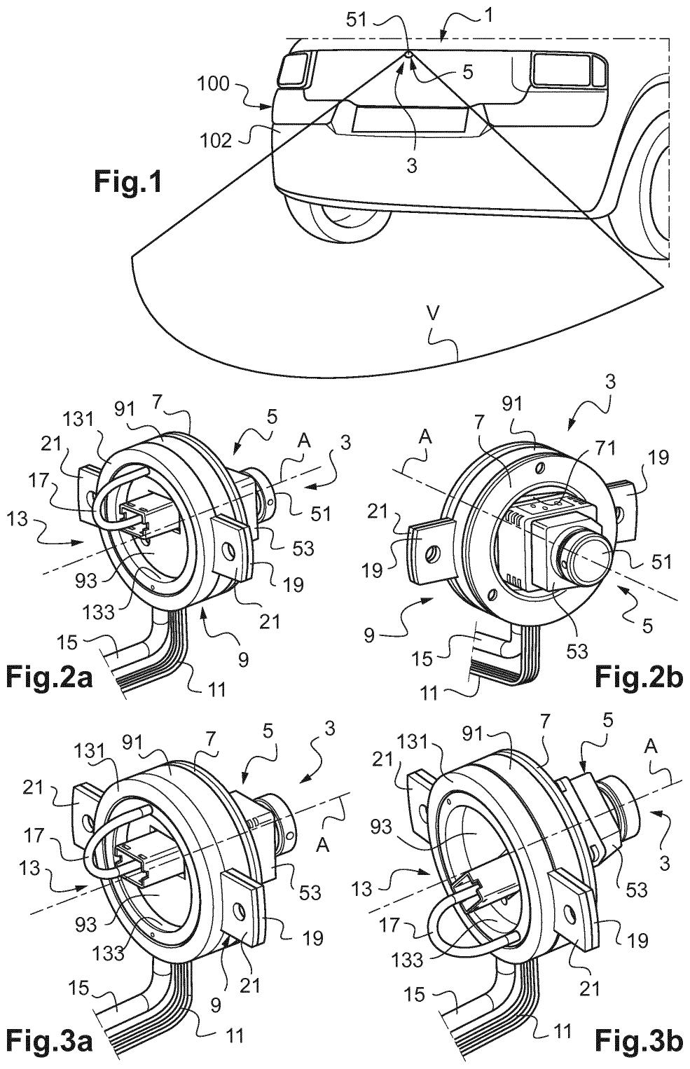

FIG. 1 schematically shows a motor vehicle provided with a driving assistance system comprising a viewing device according to the invention,

FIG. 2a is a rear perspective view of the viewing device of FIG. 1,

FIG. 2b is a front perspective view of the viewing device of FIG. 2a,

FIG. 3a is a perspective view depicting a mobile assembly of the viewing device of FIGS. 2a and 2b in a first angular position,

FIG. 3b is a perspective view depicting the mobile assembly of the viewing device of FIGS. 2a and 2b in a second angular position.

In these figures, identical elements have the same reference numbers.

The following embodiments are examples. Although the description refers to one or more embodiments, this does not necessarily mean that each reference number relates to the same embodiment, or that the features apply only to a single embodiment. Individual features of various embodiments can also be combined or interchanged in order to provide other embodiments.

FIG. 1 depicts a motor vehicle 100 provided with at least one driving assistance system 1 according to the invention.

The driving assistance system 1 notably includes at least one viewing device 3.

The viewing device 3 is intended to be fitted, for example, at a body element or at an outer element such as a rear vision mirror such as to observe the environment of the motor vehicle 100.

According to a configuration shown in FIG. 1, the viewing device 3 is positioned at the rear of the vehicle 100, at the trunk, in order to allow viewing toward the rear of the vehicle when the vehicle 100 reverses, notably for detecting the obstacles positioned behind the vehicle 100 and facilitate the parking maneuvers. The viewing device 3 can also be placed at the rear bumper 102.

According to another configuration that is not shown, the viewing device 3 can be positioned at the front of the vehicle 100, for example at the grill or the front bumper or at the license plate in order to improve forward viewing.

In an alternative, the viewing device 3 can be positioned on a side of the vehicle 100, notably instead of or in addition to the outer rear vision mirror. The viewing device 3 can be fitted both on the driver side and on the passenger side or on both. The viewing device 3 thus allows viewing to the side and toward the rear of the vehicle 100 notably to detect a vehicle arriving from the rear on an adjacent lane. Other locations can also be envisaged.

The viewing device 3 can be fixed using any known technique on the vehicle 100.

With reference to FIGS. 2a to 2b, the viewing device 3 comprises at least one optical sensor 5 and a support 7 for this optical sensor 5.

The optical sensor 5 is produced, for example, by a camera or any other type of shooting apparatus making it possible to detect one or more images in the field of vision V, schematically shown in FIG. 1, of the viewing device 3.

The optical sensor 5 (FIGS. 2a and 2b) is, for example, a shooting optical sensor 5 such as a camera. It can be a CCD (“charged coupled device”) sensor or a CMOS sensor including an array of miniature photodiodes. According to an alternative, it can be a light detection and ranging sensor called a LIDAR sensor.

The optical sensor 5 can comprise a sensor operating in the visible range. In addition or as an alternative, the optical sensor 5 can comprise an infrared sensor allowing night vision.

The viewing device 3 is, for example, associated with an operating system (not shown) for utilizing the images coming from the viewing device 3. The operating system, for example on board the motor vehicle 100 (FIG. 1), can comprise a display device (not shown) which makes it possible to display images detected by the optical sensor 5 (FIGS. 2a and 2b). The display device can be a display screen placed at the instrument panel or at the center console of the motor vehicle 100 (FIG. 1). The display can also occur via projection on an element, notably a transparent element, for example at the windshield or at a glass of the motor vehicle 100.

Advantageously, the images captured by the optical sensor 5 can be transmitted to the display device (not shown) or beforehand to an image processing means (not shown) of the operating system of the vehicle 100, by wireless communication, for example by Wi-Fi or Bluetooth, or any other means known to a person skilled in the art. Of course, this applies for the transmission of any video and/or audio signal from the optical sensor 5 to the network of the vehicle 100. Furthermore, the image processing means can be configured to apply one or more image processing operations prior to display on the display means. In particular, image processing can make it possible to obtain an image according to the desired orientation.

As can be seen more clearly in FIG. 2b, the optical sensor 5 includes optics 51 with an optical axis A. The optics 51 are, for example, a lens. These optics 51 are, for example, convex (domed) with a convexity orientated outward from the optical sensor 5, such as so-called fisheye optics.

Furthermore, according to the illustrated example, the optical sensor 5 can comprise a support casing 53 for the optics 51. The optical sensor 5 is arranged at the front of the casing 53. The front of the casing 53 extends from the casing 53 part intended to face the road scene, for which the optical sensor 5 is involved in the shooting process, when the viewing device 3 is mounted on the vehicle 100 (FIG. 1). Conversely, the rear of the casing 53 (FIGS. 2a, 2b) extends from the casing 53 part opposite the front of the casing 53; the rear of the casing 53 is therefore the part furthest from the road scene, for which the optical sensor 5 is involved in the shooting process. The optics 51 are arranged to be centered on the casing 53.

Moreover, the optics 51, in particular the external surface thereof, can have one or more of the following properties: hydrophobic, infrared filter, photocatalytic, superhydrophobic, oleophobic, hydrophilic, or superhydrophilic, resistance to chippings, or any other surface treatment making it possible to reduce the adhesion of possible fouling.

In particular, thanks to the hydrophobic properties of the optics 51, possible drops of water stream along the external surface without leaving traces since water cannot stick to this external surface. Thus, the layers or coatings on the optics 51 make it possible to limit the possibilities of the organic or inorganic pollutants sticking and the presence of traces of water on the optics 51 that can impair the correct operation of the driving assistance system 1. Advantageously, a liquid solution, such as a Rain-X® solution, can be deposited on the external surface of the optics 51 in order to form a hydrophobic film.

Furthermore, the optical sensor 5 is mounted on the support 7, while being able to rotate around a rotation axis. In particular, the rotation axis of the optical sensor 5 is merged with the optical axis A of the optical sensor 5. The rotation of the optical sensor 5 makes it possible to remove or eject, by centrifugal effect, the possible fouling lying on the latter, and in particular on the optics 51.

Since the optical sensor 5 rotates, various configurations can be envisaged for image capturing.

According to a first alternative, image capturing can be synchronized with the rotation speed of the optical sensor 5. In other words, the optical sensor 5 can be configured to capture an image each time the optical sensor is in a predetermined angular position.

According to a second alternative, the optical sensor 5 can capture images continuously irrespective of the angular position of the optical sensor 5. In this case, at least one image processing operation, in particular an image rectification, can be applied to the images taken by the optical sensor 5 before being displayed on the display device (not shown) of the vehicle 100.

With regard, more precisely, to the support 7 for the optical sensor 5, this support 7 is intended to be fixedly mounted on the motor vehicle 100 (FIG. 1). Referring again to FIG. 2b, the support 7 includes a through-housing 71 configured to at least partially receive the optical sensor 5. More precisely, the casing 53 of the optical sensor 5 is mounted such as to pass through the support 7, the optics 51 projecting with respect to the support 7.

In particular, the support 7 has a substantially annular general shape. This annular shape is, in this example, centered around the optical axis A of the optical sensor 5.

Moreover, when the support 7 receiving the optical sensor 5 is mounted on the vehicle 100, the optics 51 can be flush with the body of the vehicle 100 (see FIG. 1).

Referring again to FIGS. 2a and 2b, to rotate the optical sensor 5, the viewing device 3 furthermore includes an actuator 9.

The actuator 9 can be arranged at the rear of the viewing device 3. The rear of the viewing device 3 extends from the part opposite the optics 51 of the optical sensor 5. When the viewing device 3 is fitted on the motor vehicle 100, the rear of the viewing device 3 is the part furthest from the road scene, for which the optical sensor 5 is involved in the shooting process.

The actuator 9 is, for example, electrically powered by a supply 11 linked to the general electrical circuit of the vehicle 100 (FIG. 1).

The actuator 9 (FIGS. 2a, 2b) comprises an electric motor, for example. By way of nonlimiting example, it can more particularly be a brushless motor.

Advantageously, the motor 9 is arranged such that the rotation axis thereof is merged with the optical axis A of the optical sensor 5.

The motor 9 can have a rotation speed of between 1000 and 50000 rpm, preferably between 8000 and 20000 rpm, and yet more preferably approximately 15000 rpm. Such rotation speeds allow the elimination of possible fouling which would have been deposited on the optical sensor by centrifugal effect in order to provide optimized operation of the driving assistance system 1.

The motor 9 includes a stator 91 which is fixed and a rotor 93 that can rotate with respect to the stator 91. In the illustrated embodiment, the stator 91 is placed around the rotor 93.

Advantageously, the motor 9 is hollow and the optical sensor 5 is arranged at least partially inside the motor 9. Notably, the rear part of the casing 53 of the optical sensor 5 is received in the hollow part of the motor 9. In particular, the optical sensor 5 is centered in the motor 9.

Moreover, as can be seen in FIG. 2b, the support 7 for the optical sensor 5 can be fixed to the stator 91, by any appropriate fixing means.

In an alternative, it can be envisaged that the support 7 for the optical sensor 5 is integrated into the stator 91.

The viewing device 3 further includes a power supply means 13 for the optical sensor 5, which can be seen more clearly in FIG. 2a. This power supply means 13 must be suited to the rotating movement of the optical sensor 5. For this purpose, the power supply means 13 is configured to power the optical sensor 5 using an energy transmission technology that is at least partially wireless. The transmission of energy can occur via induction.

For this purpose, according to the example illustrated in FIGS. 2a, and 3a, 3b, the power supply means 13 comprises a fixed connector 131 and a mobile connector 133 also called a rotary connector.

The fixed connector 131 and the mobile connector 133 have, for example, a substantially annular shape. In particular, the mobile connector 133 can be arranged inside the fixed connector 131.

The fixed connector 131 is configured to be electrically powered, for example via a power supply cable 15 which can be linked to the network of the vehicle 100.

Moreover, the fixed connector 131 can be fixed to the stator 91. To this end, it is possible to provide any appropriate fixing means. In the illustrated example, it is possible to provide fixing complementary lugs 19, 21 firstly on the stator 91 and secondly on the fixed connector 131. The fixing lugs can be assembled by screwing, for example. Of course, any other fixing can be envisaged. In particular, the fixed connector 131 is arranged on the stator 91 on the opposite side to the support 7 for the optical sensor 5.

The mobile connector 133 is configured to be rotated. More precisely, the mobile connector 133 can be rotationally coupled to the optical sensor 5.

The mobile connector 133 is, for example, configured to be rotated by the actuator 9, namely by the rotor 93 of the motor 9 in the described example. The mobile connector 133 can notably be fixed to the rotor 93 by any appropriate means.

According to the described embodiment, the optical sensor 5, the rotary connector 133 and the rotor 93 form a mobile assembly of the viewing device 3. The fixed connector 131 and the stator 91 form a fixed assembly of the viewing device 3. In FIG. 3a, the mobile assembly of the viewing device 3 is in a first angular position with respect to the fixed assembly. In FIG. 3b, the mobile assembly is in a second angular position, different to the first position, with respect to the fixed assembly.

Furthermore, the mobile connector 133 is configured to be powered by the fixed connector 131 using a wireless energy transmission technology, in this example by induction. For this purpose, the fixed connector 131 can comprise a primary circuit linked to an electrical power supply for example coming from the network of the vehicle 100 via the power supply cable 15 and the mobile connector 133 can comprise a secondary circuit allowing electromagnetic coupling to the primary circuit.

The optical sensor 5 can be powered by the current induced in the mobile connector 133, for example via another power supply cable 17.

According to an alternative that is not shown, it is possible to provide a slip ring (not shown) between the optical sensor 5 and the network of the motor vehicle 100 and the operating system (not shown). Such a slip ring (not shown) makes it possible to transmit the current in order to power the optical sensor 5. The slip ring (not shown) also provides a link by cables, that are for example of coaxial type, between the optical sensor 5 and the operating system (not shown) of the motor vehicle 100, for the transmission of signals, notably video, while allowing the rotation of the optical sensor 5. In other words, in this case, the images captured by the optical sensor 5 can be transmitted to the display device (not shown) or beforehand to an image processing means (not shown) of the operating system of the vehicle 100, by such cables.

By way of nonlimiting example, it is possible to mention in a non-exhaustive manner, electrical slip rings, capsule slip rings, and slip rings according to the HD-SDI, meaning “high definition serial digital interface”, standard.

Moreover, to improve the state of cleanliness of the optics 51, which can be better seen in FIG. 2b, optionally it is possible to provide at least one nozzle (not shown) for spraying a cleaning fluid onto the optics 51. This makes it possible to provide additional cleaning of the optics 51 if the rotation of the optical sensor 5 is not sufficient to eliminate the possible fouling deposited on the optics 51. This nozzle (not shown) can be located on the body of the vehicle 100 (FIG. 1) close to the optics 51, for example above the optics 51. The cleaning fluid can be compressed air and/or a cleaning liquid.

Various configurations can also be envisaged for managing the activation of the viewing device 3, i.e. the activation of the optical sensor 5, and for managing the maintenance of the visibility of the optical sensor 5.

The viewing device 3 can be activated constantly when the vehicle 100 is used. In this case, the viewing device 3 is activated when the vehicle 100 is started and the images coming from the optical sensor 5 can be displayed constantly or upon request.

Alternatively, the viewing device 3 can be activated only when the user actuates a predetermined command, for example a dedicated command or when reverse is engaged in the case of a rear viewing device 3 to allow parking assistance. For this purpose, the viewing device 3 is, for example, coupled to a device for engaging the reversing of the motor vehicle 100, for example a transmission.

With regards to managing the maintenance of the visibility of the optical sensor 5 (which can be seen in FIGS. 2a to 3b), a method for protecting or a method for maintaining visibility can be implemented. This method comprises at least one step for rotating the optical sensor 5 such as to remove the possible fouling by centrifugal effect. To this end, the driving assistance system 1 can comprise an electronic control unit, not shown in the figures, notably configured to activate the actuator 9 such as to rotate the optical sensor 5. Of course, to be able to clean by centrifugal effect, the optical sensor 5 is rotated with a nonzero rotation speed.

The optical sensor 5 can be rotated constantly when the vehicle 100 operates, i.e. during the driving stages or when it has stopped but is switched on.

In an alternative, the optical sensor 5 can be rotated intermittently when the vehicle 100 operates, for example when the user of the vehicle uses a functionality of the vehicle requiring the use of the optical sensor 5, such as when the user uses reverse.

The method can comprise at least two steps with an optical sensor 5 rotation speed that is different for each step.

According to a specific embodiment, the method can include a step for changing the rotating direction of the optical sensor 5. Advantageously, the rotating direction of the optical sensor 5 can be modified several times over a predefined time period, that is relatively quick. This modification of the rotating direction promotes the occurrence of acceleration phenomena and makes it possible to effectively eliminate possible small drops of water which would be found substantially at the center of the optics 51 for example. Indeed, the variation in the rotating direction of the optics 51 subjects the fouling to an acceleration in the reverse direction to the movement thereof which facilitates the loss of grip thereof to the optics 51 and therefore the ejection thereof. The method can also comprise at least one step for spraying at least one cleaning fluid onto the optics 51. The electronic control unit (not shown) of the vehicle 100 can be configured to trigger the spraying of at least one cleaning fluid, such as compressed air or cleaning liquid, for example, onto the optics 51.

This spraying step can be triggered, for example, after detecting fouling in the field of vision V of the optical sensor 5 (see FIG. 1).

Alternatively or additionally, the spraying of at least one cleaning fluid can be triggered depending on the speed of the vehicle 100, for example when the vehicle 100 has stopped or when it moves at low speed, i.e. notably at a speed less than 15 km/h. Indeed, in such a case, it is possible that the aerodynamic forces may not be sufficient to be combined effectively with the centrifugal force of the rotation of the optical sensor 5 such as to eliminate the drops of water and/or the fouling which can be deposited on the optics 51. In particular, the small drops of water that are located at the center or close to the center of the optics 51 can be difficult to eliminate.

The spraying of fluid can also take place according to a time delay, for example at the end of a certain duration for driving the vehicle 100, or upon the request of the user of the vehicle 100.

According to a specific embodiment of the invention, it is possible to provide a step for stopping the actuator 9 such as to stop the optical sensor 5 from rotating followed by a step of spraying one or more fluids, then a step of reactivating the actuator 9 in order to rotate the optical sensor 5 again.

Alternatively or additionally, the method can include at least two steps, each with a different rotation speed for the optical sensor 5.

By way of nonlimiting example, it is possible to provide:
a first step for spraying cleaning fluid onto the optics 51, during which the optical sensor 5 is rotated according to a first rotation speed, and
a second drying step, during which the optical sensor 5 is rotated according to a second rotation speed that is different to the first rotation speed.

The first rotation speed is, in this example, advantageously less than the second rotation speed. Thus, the first rotation speed can be relatively low, or slowed down if the casing 53 was already rotated. This makes it possible to facilitate the spread of the cleaning fluid.

The triggering of the second drying step can be delayed. After a predefined period of time, for example that is relatively short, the rotation speed can be accelerated, making it possible to dry the external surface of the optics 51, helping to eliminate the fouling wetted by the cleaning liquid.

Advantageously, with such an embodiment, the quantity of cleaning fluid for cleaning is clearly less than a conventional cleaning system from the prior art that does not use rotation.

Moreover, the rotation speed of the optical sensor 5 can be adjusted during the implementation of the method for maintaining visibility. For example, the rotation speed can be adjusted according to the speed of movement of the vehicle 100. Indeed, the fouling is eliminated from the optics 51 thanks to the action of the centrifugal force linked to the rotation of the optical sensor 5, and possibly combined with the friction linked to the movement of the vehicle 100, in particular when the driving assistance system 1 is located at the front of the vehicle 100.

Thus, the higher the speed of movement of the vehicle 100, the less the rotation speed of the optical sensor 5 needs to be high in order to retain a good state of cleanliness of the optics 51 and therefore an optimized operation of the optical sensor 5. The electronic control unit can be configured to act on the actuator 9 such as to reduce the rotation speed of the optical sensor 5 when the speed of the vehicle 100 increases, notably when the optics 51 are fitted at the front of the vehicle.

Conversely, when the vehicle 100 moves at low speed, the rotation speed of the optical sensor 5 can be increased. Thus, the electronic control unit can be configured to act on the actuator 9 such as to increase the rotation speed of the optical sensor 5 when the speed of the vehicle 100 decreases.

Thus, the optics 51 are protected from the possible projection of fouling such as organic or inorganic pollutants, water or a combination of these various elements, that can damage it.

Indeed, during the rotation of the optical sensor 5, the centrifugal force that the possible fouling endures is greater than the grip of this fouling to the optics 51. The possible fouling deposited on the external surface of the optics 51 is then ejected and no longer interferes with the field of vision V of the optical sensor 5 which remains clear and clean.

Maintaining visibility of the optical sensor 5 is then “unnoticeable” to the user, i.e. without affecting the quality of vision and makes it possible to maintain a similar image quality regardless of the environmental or weather conditions and notably when the optical sensor 5 rotates.

Furthermore, protecting or maintaining the visibility of the optical sensor 5 by rotating the latter no longer requires a large quantity of cleaning liquid as in the solutions of the prior art proposing cleaning of the optical sensor 5 with a cleaning liquid jet without rotating the optical sensor 5.

1. A viewing device for a motor vehicle comprising:
an optical sensor configured to take at least one image of a road scene;
a support for the optical sensor,
wherein the optical sensor is rotatably mounted on the support; and
an actuator configured to rotate the optical sensor.

2. The device as claimed in claim 1, further comprising a means for supplying power to the optical sensor using an energy transmission technology that is at least partially wireless.

3. The device as claimed in claim 2, wherein the power supply means comprises:
a fixed connector configured to be electrically powered, and
a mobile connector configured to be powered by electromagnetic coupling to the fixed connector and configured to power the optical sensor with the induced current.

4. The device as claimed in claim 3, wherein the mobile connector is rotationally coupled to the optical sensor.

5. The device as claimed in claim 1, wherein the rotation axis of the optical sensor is merged with the optical axis of the optical sensor.

6. The device as claimed in claim 3, wherein the actuator comprises a motor with a fixed stator and a rotor mobile with respect to the stator.

7. The device as claimed in claim 6, wherein the fixed connector is fixed to the stator and the mobile connector is fixed to the rotor.

8. The device as claimed in claim 6, wherein the motor is hollow and the optical sensor is arranged at least partially inside the motor.

9. The device as claimed in claim 6, wherein the support is fixed to the stator.

10. The device as claimed in claim 7, wherein the fixed connector is arranged on the stator on the opposite side to the support for the optical sensor.

11. The device as claimed in claim 1, wherein the support has a through-housing for at least partially receiving the optical sensor.

12. The device as claimed in claim 1, wherein the optics of the optical sensor have at least one property selected from the group consisting of: infrared filter photocatalytic, hydrophobic, superhydrophobic, oleophobic, hydrophilic, superhydrophilic, resistance to chippings.

13. A driving assistance system comprising at least one viewing device as claimed in claim 1.

14. A method for maintaining the visibility of an optical sensor of a viewing device as claimed in claim 1, said method comprising rotating the optical sensor.
